(19) United States
(12) Patent Application Publication
(10) Pub. No.: US 2012/0318465 A1
(43) Pub. Date: Dec. 20, 2012

(54) INSULATING SHADE FOR COVERING AN ARCHITECTURAL OPENING

(75) Inventor: Wendell B. Colson, Weston, MA (US)

(73) Assignee: Hunter Douglas Inc., Pearl River, NY (US)

(21) Appl. No.: 13/519,952

(22) PCT Filed: Dec. 31, 2010
(86) PCT No.: PCT/US10/62624

§ 371 Date: Aug. 1, 2012

Related U.S. Application Data
(60) Provisional application No. 61/291,395, filed on Dec. 31, 2009.

(51) Int. Cl. E06B 9/68; E06B 9/42

(52) U.S. Cl. 160/7; 160/238; 160/41; 160/309

(57) ABSTRACT

An insulating shade assembly for an architectural opening includes a roller and an insulating shade. The insulating shade includes a shade core attached to and between first and second outer shade sheets. The shade core includes a number of inner shade sheets which are stacked upon one another and attached to one another in an offset manner. The shade core is expanded by moving the first and second outer shade sheets relative to one another, creating a number of cells for insulating air.

### CROSS REFERENCE TO RELATED APPLICATION

This application claims priority under 35 U.S.C. §119(e) to co-pending U.S. provisional patent application No. 61/291,395 entitled “Insulating Shade for Covering an Architectural Opening” filed on 31 Dec. 2009, which is hereby incorporated by reference herein in its entirety.

### BACKGROUND OF THE INVENTION

1. Field of the Invention

The present invention relates to a vertically hanging, insulating shade for covering an architectural opening, such as a door or a window. More specifically, the present invention is a roll-up shade which provides insulation against heat transmission between the inside of a room and the outwardly facing side of the shade by expanding in thickness when in a closed or unrolled state.

2. Description of the Related Art

Window shade systems are well known in the art and are frequently used as functional window coverings to regulate the amount of light or air entering a room. Roll-up shade systems typically include a roller and a shade sheet which is attached to and rolled around the roller, so that the shade may be disposed in completely closed (unrolled) or opened (rolled-up) states, or at intermediate states therebetween. When the shade is completely rolled up, the window is uncovered, and light or air is able to pass between the outdoors and the inside of the room through the window. The shade may typically be unrolled from the roller by pulling it down to the desired position, so that it covers the opening and prevents light and air passage through the window.

Generally speaking, known roll-up window shade systems include either a single shade sheet or a pair of thin sheet plies connected to one another in some manner. As such, these known shades may be readily rolled around the roller when opening the shade, but do not provide much insulation against heat transfer from one side of the shade to the other. To make matters worse, air and light are able to pass freely through gaps between the window frame and the sides, top, and bottom of the shade. As a result, roll-up shade systems of the prior art allow heat to flow easily between the outwardly facing side of the shade and inside of the room, making them inadequate for insulating the room. When the temperature difference between the outdoors and the indoors is high, the room may have considerable heat loss or gain, depending on the season, against which the shade provides little benefit.

For example, U.S. Pat. Nos. 4,039,019 and 4,194,550 to Hopper show an apparatus for insulating against conductive, convective, and radiant heat transmission. The apparatus comprises three or more mutually parallel sheets. The sheets may be attached to a retracting device from which they can be drawn to extend in mutually parallel relation and cover a building opening, such as a window, or they can be retracted to uncover the opening. A number of spacers, which may be in the form of collapsible or nestable devices, are mounted within the apparatus to separate each pair of adjacent sheets and, thus, define a dead-air space therebetween. In U.S. Pat. No. 4,039,019, at least one of the sheets has a highly radiation-reflective surface located to face on a dead-air space. In U.S. Pat. No. 4,194,550, at least one of the sheets has a surface, facing on a dead-air space, exhibiting a low surface emittance. This surface emittance is sufficiently low to yield a total effective emissivity of the surface and dead-air space of no greater than 0.60. Importantly, the spacer devices are designed not to abrade or otherwise harm the reflective or low surface emittance surface. The combination of the dead-air spaces with the highly radiation-reflective or low emittance sheet surfaces results in an apparatus having low effective emissivity that effectively impedes radiant heat transfer. The dead-air spaces also effectively impede conductive and convective heat transfer.

Insulating window coverings are also known in the art. There are, however, problems with these window coverings. One problem is that window coverings that provide adequate insulation against heat transfer are bulky and, as such, are not easily stored, because they cannot be rolled up like a thin window shade. Accordingly, such window coverings must be placed over a window or a door when insulation is desired, and then removed or tied back to allow light or air to pass through the opening.

### SUMMARY OF THE INVENTION

In view of this brief description of the shortcomings of insulating shade systems of the prior art, it is an objective of the present invention to provide an insulating shade assembly which is designed to insulate against outdoor temperature extremes and which assumes a compact form when in a rolled state.

Accordingly, the insulating shade assembly of the present invention comprises a roller, the roller being an elongated, substantially cylindrical member. The roller is rotatable about a longitudinal axis to roll and unroll a shade. The roller has a first side and a second side, which are opposite sides thereof when the roller is oriented with the longitudinal axis oriented horizontally, such as, front and back, or near side and far side.

The insulating shade assembly also has a shade attached to the roller. The shade includes a first outer shade sheet, which has a first end and a second end. The first end of the first outer shade sheet is attached to the first side of the roller. The shade also includes a second outer shade sheet, which has a first end and a second end. The first end of the second outer shade sheet is attached to the second side of the roller.

A shade core is between the first and second outer shade sheets. The shade core has a first side and a second side. The first side is attached to the first outer shade sheet and the second side is attached to the second outer shade sheet. The shade core comprises a plurality of inner shade sheets. The inner shade sheets are stacked upon one another in an offset manner and attached to one another in an offset manner. As a consequence, when the first and second outer shade sheets are moved in opposite directions relative to one another by the rotation of said roller, the shade core is opened to form a plurality of insulating cells bounded by the inner shade sheets.

The insulating shade assembly may also include a bottom support member. The bottom support member is a substantially rectangular member having a first side, a second side, and a width. The second end of the first outer shade sheet is attached to the bottom support member at the first side and the second end of the second outer shade sheet is attached to the bottom support member at the second side. The insulating shade assembly may also include a weight on one of the two sides of said bottom support member.

In order to function most effectively as an insulator, the insulating shade assembly of the present invention is best installed in such a way that air cannot pass readily around its top, bottom, and side edges when it is in an architectural opening. To this end, the insulating shade assembly also includes a first edge track and a second edge track along the two sides of the architectural opening, the roller being mounted between the first and second edges tracks substantially at the top of the architectural opening. The first and second edge tracks each have a substantially C-shaped cross section. In this way, when the insulating shade is unrolled to a closed condition and expands, the first and second outer shade sheets press against the edge tracks to seal any gaps along the sides of the shade. A seal plate may be used at the top of the shade between the two edge tracks to seal any gap present there. When closed, the insulating shade makes contact with the bottom of the architectural opening, such as a window sill, to seal any gap there.

The insulating shade assembly of the present invention preferably has a motorized drive system for opening and closing the shade. A sensor responsive to an environmental stimulus may be operatively connected to the motorized drive system, so that the shade may be operated in response to the environmental stimulus without operator intervention.

The present invention will now be described in more complete detail with frequent reference being made to the figures identified below.

### BRIEF DESCRIPTION OF THE DRAWINGS

FIG. 1 is a side elevational view of an insulating shade assembly in an unrolled state;

FIG. 2 is a schematic representation of the assembly of inner shade sheets to form a shade core;

FIG. 3 is an elevational view of the insulating shade assembly installed in a window opening in a building;

FIG. 4 is a cross sectional view taken as indicated in FIG. 3; and

FIG. 5 is a cross-sectional view taken as indicated in FIG. 3.

### DETAILED DESCRIPTION OF THE PREFERRED EMBODIMENTS

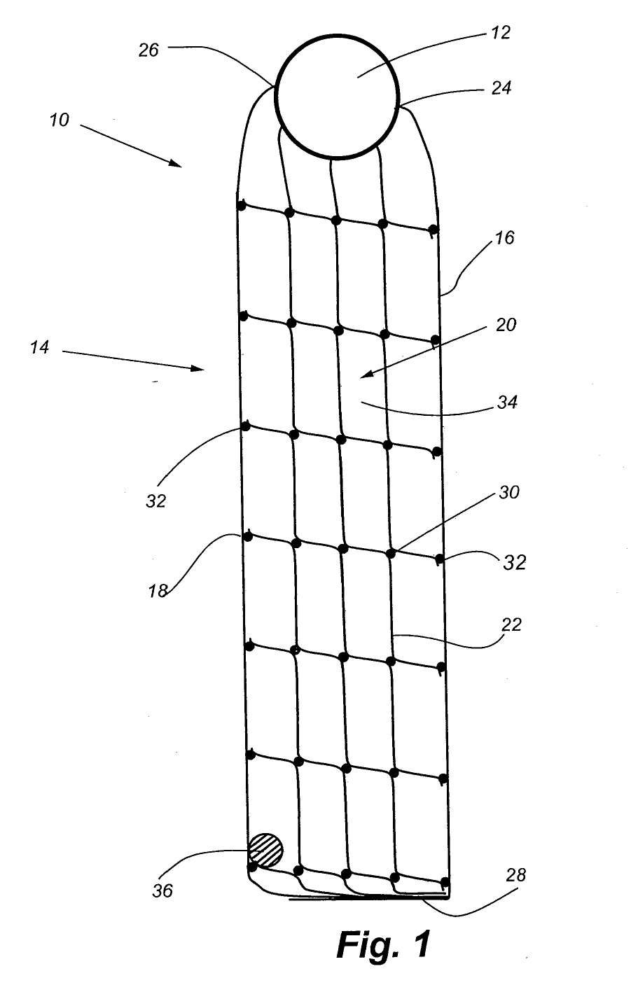

Turning now to these figures, FIG. 1 is a side elevational view of an insulating shade assembly, generally designated 10, comprising a roller 12 and a shade 14, in a closed or unrolled state. The shade 14 comprises a plurality of shade sheets which include a first outer shade sheet 16 and a second outer shade sheet 18. Between the first and second outer shade sheets 16,18 is a shade core 20 comprising a plurality of inner shade sheets 22. The first outer shade sheet 16 is attached to the roller 12 at a first attachment point 24, and the second outer shade sheet 18 is attached to the roller 12 at a second attachment point 26. A bottom support member 28, having a length about equal to the width of the shade 14 and a width that may be wider than the diameter of the roller 12, is disposed at the bottom of the shade core 20. The bottom ends of the first and second outer shade sheets 16,18 are attached to the underside of the bottom support member 28, where they may overlap with one another.

Referring now more particularly to the shade core 20, inner shade sheets 22 are attached to those on either side in an offset manner, to be described in more explicit detail below, at attachment points 30, represented by dots in FIG. 1. Inner shade sheets 22 are also attached to either or both of first outer shade sheet 16 and second outer shade sheet 18 at attachment points 32. When the shade is unrolled to the closed state shown in FIG. 1 by rotating roller 12 in a counterclockwise direction, the shade core 20 is expanded by the movement of second outer shade sheet 18 relative to first outer shade sheet 16 during the final half-rotation of the roller 12, which movement opens cells 34, formed between adjacent inner shade sheets 22 and between inner shade sheets 22 and either of the first and second outer shade sheets 16,18. The cells 34, which become filled with air, provide the insulation to inhibit the passage of heat through the shade 14.

Insulating shade assembly 10 further comprises a weight 36 attached on or under bottom support member 28 along the edge or side thereof where second outer shade sheet 18 passes around and under. Weight 36 maintains shade 14 in a taut condition while it is being either rolled around or unrolled from roller 12, and facilitates the opening of cells 34 when shade 14 is fully unrolled.

When the shade 14 is completely rolled up, accomplished by rotating roller 12 clockwise from the condition shown in FIG. 1, the bottom support member 28 is suspended more or less vertically from the roller 12 with weight 36 being along the top edge of member 28. The shade 14 itself is fully collapsed and wound around roller 12. As the shade 14 is unwound from this completely rolled up condition, weight 36 particularly maintains second outer shade sheet 18 in a taut condition, while bottom support member 28 hangs more or less vertically therefrom. As second outer shade sheet 18 becomes fully unwound, roller 12 separates first outer shade sheet 16 from second outer shade sheet 18, causing bottom support member 28 to assume a more or less horizontal condition and opening cells 34, thereby reaching the condition shown in FIG. 1. In the reverse operation, rotating roller 12 clockwise from the condition shown in FIG. 1, second outer shade sheet 18 is raised, causing bottom support member 28 to rotate to a more or less vertical condition below second outer shade sheet 18 and pulling first outer shade sheet 16 toward second outer shade sheet 18 to collapse cells 34, allowing shade 14 to be compactly stored around the roller 12.

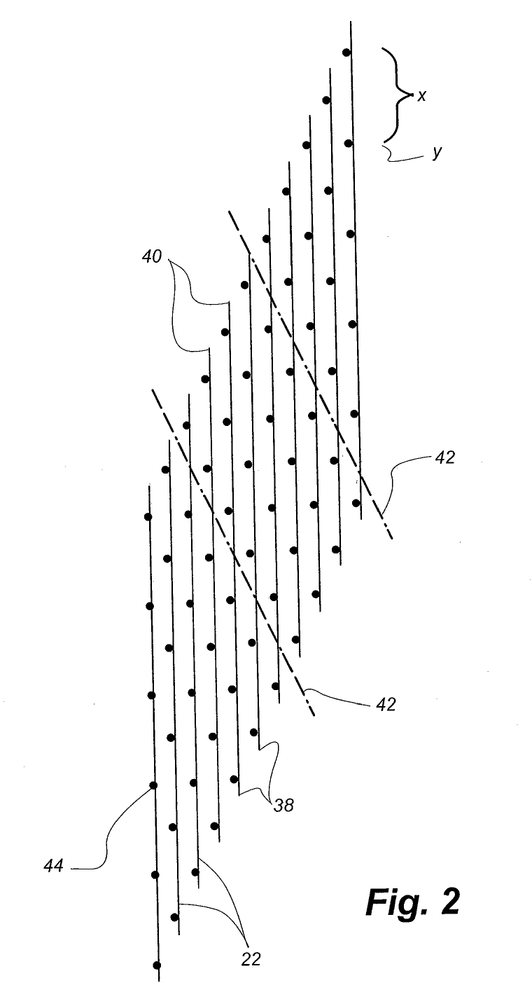

FIG. 2 is a schematic representation of the assembly of inner shade sheets 22 to form shade core 20. The vertical spacing between individual inner shade sheets 22 is somewhat exaggerated in FIG. 2 to facilitate discussion; in reality, each inner shade sheet 22 is very thin, as is the entire stacked assembly which forms the shade core 20.

Each inner shade sheet 22 has a plurality, in this case, five, equally spaced glue lines 44 parallel to one another and extending thereacross. Inner shade sheets 22 are deposited, one after another, on an incrementally moving conveyor, which may be either the first outer shade sheet 16 or the second outer shade sheet 18, in the offset manner shown in FIG. 2. Where the conveyor is either the first or second outer shade sheet 16,18, it, too, would have glue lines, equally spaced from one another, so that the left tail ends 38 of the inner shade sheets 22 could be secured thereto. As a consequence, each inner shade sheet 22 is deposited on that previously deposited by a uniformly offset amount. Finally, the other of the first and second outer shade sheets 16,18 may be deposited onto the stacked inner shade sheets 22 and attached by gluing to right tail ends 40. Finally, a heat treatment with pressure is used to activate the glue and to bond the various sheets 16,18,22 at the desired points. In this manner, a supply of shade 14 may be assembled, stored, and subsequently cut to desired lengths. It being recalled that the assembly shown in FIG. 2 is in reality quite flat, the cutting would be done, for example, at dashed lines 42, to produce a shade of any desired length. It should be noted in FIG. 2 that distance “X”, the offset between glue lines on adjacent inner shade sheets 22, determines the length of the S-shaped top and bottom of each cell 34, while the distance “Y” determines the height of each cell 34.

Having provided this description of the assembly of the shade core 20 and shade 14, it is of interest to note that inner shade sheets 22 may be of a woven or nonwoven fabric material for shades 14 intended for use only as insulating shades without any black-out function. Where it is of interest to provide the shade with a black-out capability, alternate inner shade sheets 22 may be of an aluminized polyester film, sold under the trademark MYLAR®, it having been found in practice that a shade core 20 entirely comprised of such film tends to be difficult to expand, as individual sheets, being impermeable to air, do not quickly separate from one another from a collapsed state.

The first and second outer shade sheets 16,18 may also be of a woven or nonwoven fabric material. In addition, the second outer shade sheet 18, which, when the insulating shade assembly 10 is installed for use, faces inside the building, may have a decorative fabric layered on top for aesthetic appeal. Moreover, the second outer shade sheet 18 may include a vapor barrier to prevent humidity in the room air from passing through and condensing inside the cooler shade 14 or on the window pane. Finally, the first outer shade sheet 16, which, when the insulating shade assembly 10 is installed for use, faces the window pane, may have a super-white coating to minimize solar heat gain in the space between the first outer shade sheet 16 and the window pane.

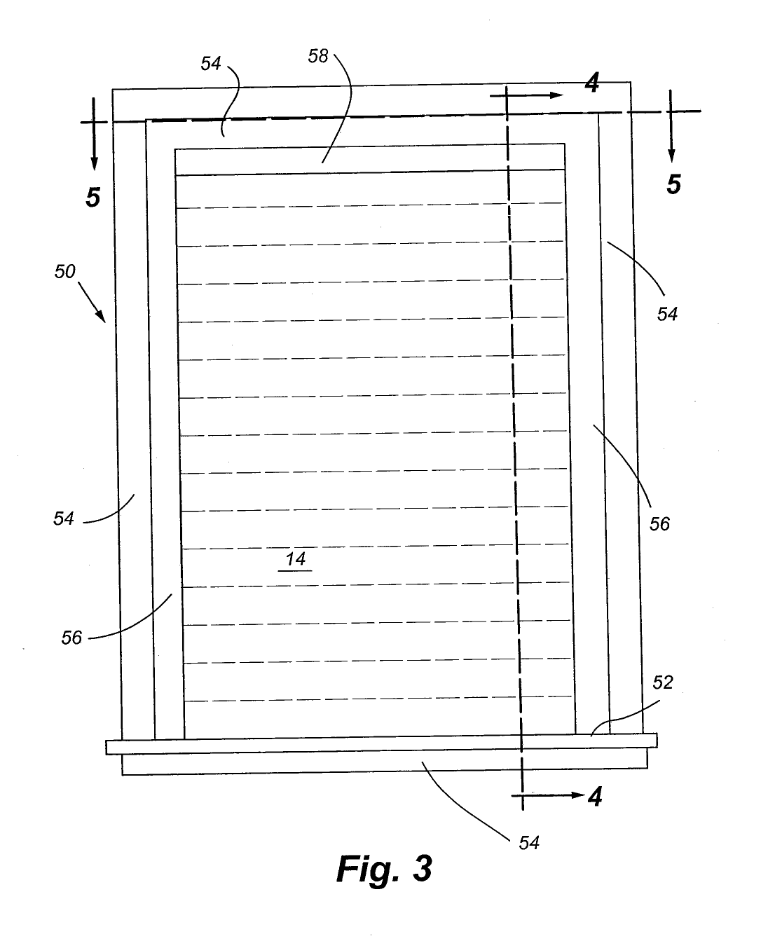

FIG. 3 is an elevational view of the insulating shade assembly 10 installed in a window opening 50 in a building. The view in FIG. 3 is from inside the building. The window opening 50 includes a frame having a sill 52 and molding 54 installed around the frame. Within the frame, the insulating shade assembly 10 is disposed in a manner to be described below; only the shade 14 is visible in this elevational view.

Along the sides of the window frame are edge tracks 56. It will be seen below that edge tracks 56 have a substantially C-shaped cross section. Across the top of the window frame is a seal plate 58. When the shade 14 is lowered and closed to assume the condition shown in FIG. 3, it expands, as discussed above, and presses against the edge tracks 56 and seal plate 58 to prevent room air from passing around the top and sides of the shade 14.

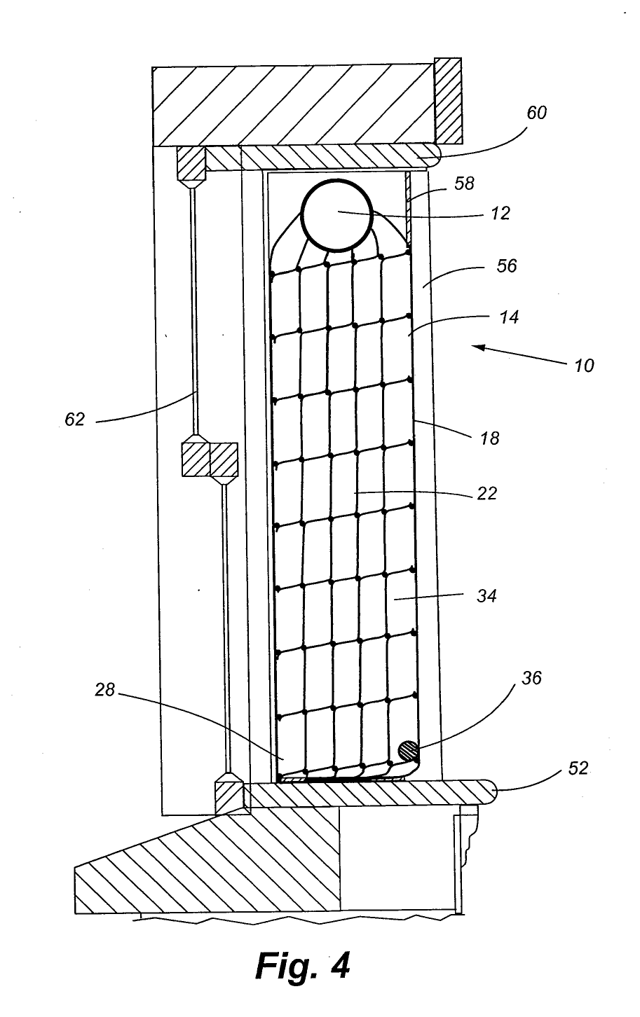

FIG. 4 is a cross sectional view taken as indicated in FIG. 3. Extending between the top member 60 of the window frame and the sill 52 is one of the two edge tracks 56. The seal plate 58 appears in cross section at the top of the shade 14. The inside of the building is at the right side of the figure. When the shade 14 is completely closed as shown in FIG. 4, the shade 14 insulates the inside of the building from air that might be heated or chilled by contact with and proximity to the window 62. It should be noted that weight 36 ensures a close contact between the bottom of the shade 14 and the sill 52 to prevent air passage under the shade 14.

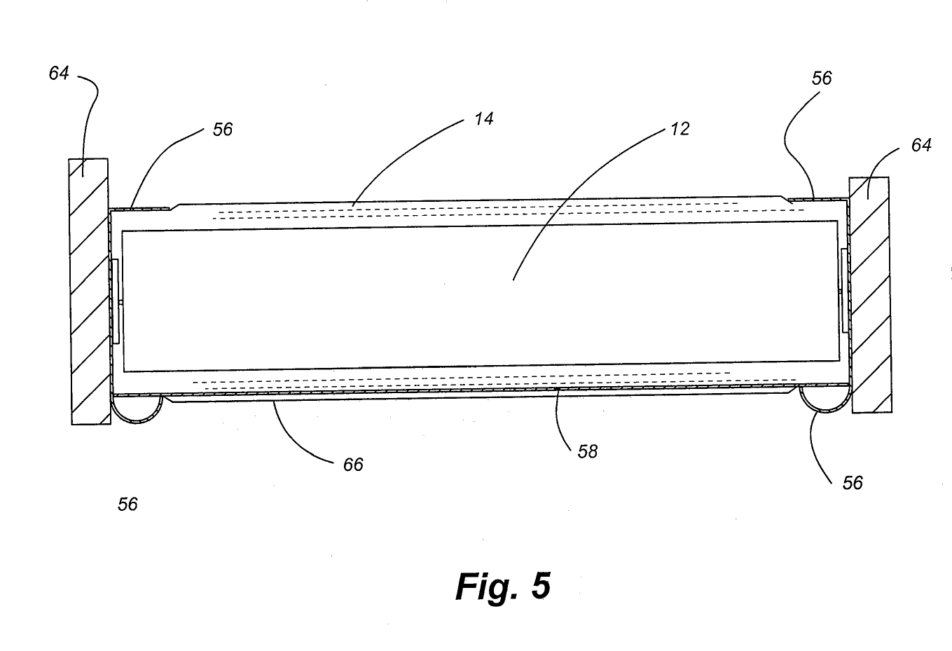

FIG. 5 is a cross-sectional view taken as indicated in FIG. 3. Edge tracks 56 are attached to side members 64 of the window frame, and can be seen to have the substantially C-shaped cross section referred to earlier. On the side of the shade 14 facing the inside of the building, that is, the bottom of FIG. 5, the edge tracks 56 are rounded in a bullnose shape to create a compression seal with the shade 14. Seal plate 58 is also shown in cross section, and a portion 66 of shade 14 bulges outward past the edge tracks 56 and seal plate 58 to seal the shade 14 thereagainst. Roller 12 extends across the window frame between the edge tracks 56 as shown.

It is preferred that the insulating shade assembly 10 of the present invention include a motorized drive system for opening and closing the shade 14. Essentially, this eliminates the need to pass control cords from within the edge track 56 to the outside, thereby possibly compromising the seal between the shade 14 and the edge tracks 56 and seal plate 58. More importantly, the motorized drive system may be designed to be activated by environmental conditions, such as darkness, light, or changes in temperature, using appropriate sensors, to operate (open or close) the shade 14 in response to environmental stimuli without operator intervention.

Modifications to the above would be obvious to those of ordinary skill in the art, but would not bring the invention so modified beyond the scope of the appended claims.

1. An insulating shade assembly for covering an architectural opening, said insulating shade assembly comprising:
a roller, said roller being an elongated, substantially cylindrical member having a first side and a second side; and
a shade, said shade being attached to said roller and comprising:
a first outer shade sheet, said first outer shade sheet having a first end and a second end, said first end being attached to said first side of said roller;
a second outer shade sheet, said second outer shade sheet having a first end and a second end, said first end being attached to said second side of said roller; and
a shade core, said shade core having a first side and a second side, said first side being attached to said first outer shade sheet and said second side being attached to said second outer shade sheet, said shade core comprising a plurality of inner shade sheets, said inner shade sheets being stacked upon one another in an offset manner and attached to one another in an offset manner, so that, when said first and second outer shade sheets are moved in opposite directions relative to one another by the rotation of said roller, said shade core is opened to form a plurality of insulating cells bounded by said inner shade sheets.

2. The insulating shade assembly as claimed in claim 1 further comprising a bottom support member, said bottom support member being a substantially rectangular member having a first side, a second side, and a width, said second end of said first outer shade sheet being attached to said bottom support member at said first side and said second end of said second outer shade sheet being attached to said bottom support member at said second side.

3. The insulating shade assembly as claimed in claim 2 further comprising a weight on one of said two sides of said bottom support member.

4. The insulating shade assembly as claimed in claim 1 further comprising a first edge track and a second edge track, said first edge track being adapted for mounting along one of two sides of said architectural opening and said second edge track being adapted for mounting along the other of said two sides of said architectural opening, said roller being mounted between said first and second edges tracks substantially at the top of said architectural opening.

5. The insulating shade assembly as claimed in claim 4 wherein said first and second edge tracks have a substantially C-shaped cross section.

6. The insulating shade assembly as claimed in claim 5 wherein one side of said substantially C-shaped cross section has a bullnose shape.

7. The insulating shade assembly as claimed in claim 4 further comprising a seal plate adapted to extend between said first and second edge tracks substantially at the top of said architectural opening.

8. The insulating shade assembly as claimed in claim 1 further comprising a motorized drive system for opening and closing the shade.

9. The insulating shade assembly as claimed in claim 8 further comprising a sensor responsive to an environmental stimulus operatively connected to said motorized drive system, so that said shade may be operated in response to said environmental stimulus without operator intervention.

10. The insulating shade assembly as claimed in claim 1 wherein one of said first and second outer shade sheets includes a vapor barrier.

11. The insulating shade assembly as claimed in claim 1 wherein said inner shade sheets are of a fabric material.

12. The insulating shade assembly as claimed in claim 1 wherein alternate ones of said inner shade sheets are of a fabric material and alternate with inner shade sheets of an aluminized polyester film.

13. The insulating shade assembly as claimed in claim 1 wherein said first and second outer shade sheets are of a fabric material.

14. The insulating shade assembly as claimed in claim 1 wherein one of said first and second outer shade sheets has decorative film layered thereon.

15. A covering for an architectural opening comprising:
a roller; and
a shade operably connected to said roller and configured to be wound and unwound around said roller, said sheet including
a first sheet;
a second sheet; and
a shade core positioned between said first sheet and said second sheet, said shade core including a plurality of inner shade sheets stacked upon one another in an offset manner and operably connected to one another in an offset manner, wherein
when said first sheet and said second sheet are moved in opposite directions relative to one another by the rotation of said roller, said shade core is opened to form a plurality of insulating cells bounded by said inner shade sheets.

16. The covering of claim 15, wherein each of said plurality of inner shade sheets forms a boundary for at least two or more of said plurality of cells.

17. The covering of claim 15, further including a weight operably connected said second sheet and configured to maintain said second sheet in a taut condition when said covering is an extended position.

18. The covering of claim 15, further including a support member operably connected to said shade, wherein in an extended position said support member extends from said first sheet towards said second position.

19. The covering of claim 18, wherein as said shade unwinds from said roller, said support member extends substantially in the same plane as said first sheet.

20. The covering of claim 15, further comprising
a first edge track configured to be mounted along one or two sides of said architectural opening; and
a second edge track configured to be mounted along the other of said two sides of said architectural opening; wherein
said roller is mounted between said first and second edges tracks substantially at a top of said architectural opening.
